(19) United States
(12) Patent Application Publication
(10) Pub. No.: US 2021/0298307 A1
(43) Pub. Date: Sep. 30, 2021

(54) COMPOSITION FOR CONTROLLING AND PREVENTING BACTERIAL WILT

(71) Applicant: CH BIOTECH R&D CO., LTD., Nantou City (TW)

(72) Inventors: Chao-Min WANG, Nantou City (TW); Cho-Chun Huang, Nantou City (TW); Gui-Jun Li, Nantou City (TW); Kai Xia, Nantou City (TW)

(21) Appl. No.: 17/208,025

(22) Filed: Mar. 22, 2021

(30) Foreign Application Priority Data
Mar. 24, 2020 (TW) 109109862

(51) Int. Cl. A01N 43/90; A01N 25/08

(52) U.S. Cl. CPC A01N 43/90; A01N 25/08

(57) ABSTRACT

A composition for controlling and preventing bacterial wilt includes auxin and cytokinin. A method for controlling and preventing bacterial wilt by using the composition is also provided.

### CROSS-REFERENCE TO RELATED APPLICATIONS

This non-provisional application claims priority under 35 U.S.C. § 119(a) on Patent Application No(s). 109109862 filed in Taiwan, on Mar. 24, 2020, the entire contents of which are hereby incorporated by reference.

### BACKGROUND OF THE INVENTION

### 1. Field of the Invention

The invention relates to a composition for controlling and preventing bacterial wilt. More particularly, the present invention relates to a composition including auxin and cytokinin for controlling and preventing bacterial wilt.

### 2. Description of the Prior Art

Bacterial wilt is a plant disease caused by the Gram-negative bacteria Ralstonia solanacearum, which is widely distributed and is the deadliest bacterial pathogen in tropical and subtropical areas. This bacterium affects a broad host range (over 200 plant species), including tomato, potato, eggplant, sweet pepper, tobacco, strawberry, radish, sweet potato, and other important economic crops, and causes serious losses to these crops.

R. solanacearum is a soil-borne bacterium. Once the pathogen exists in the field and infects host plants, with hot and humid conditions, it will cause considerable losses and even no harvest in severe cases. There is no suitable chemical that effectively prevents the occurrence of bacterial wilt, which can only be controlled by management, such as breeding for resistance to R. solanacearum, crop rotation, grafting, reducing humidity, intertillage operations, and removal of pathogens. However, the effect of the current control methods is very limited. Therefore, it is urgent and necessary to develop new methods for controlling and preventing bacterial wilt to effectively improve resistance to bacterial wilt infection in plants.

### SUMMARY OF THE INVENTION

In one aspect, the present invention relates to a concentrate composition for controlling and preventing bacterial wilt. The composition comprises between about 1 g/L to about 50 g/L auxin and between about 5 g/L to about 50 g/L cytokinin.

In another aspect, the present invention relates to a ready to use composition for controlling and preventing bacterial wilt. The composition comprises between about 1 mg/L to about 50 mg/L auxin and between about 5 mg/L to about 50 mg/L cytokinin.

In another aspect, the invention relates to a method for controlling and preventing bacterial wilt. The method comprises a step of applying a ready to use composition for controlling and preventing bacterial wilt to a plant susceptible to bacterial wilt. The ready to use composition for controlling and preventing bacterial wilt comprises between about 1 mg/L to about 50 mg/L auxin and between about 5 mg/L to about 50 mg/L cytokinin. The present invention is illustrated but not limited by the following embodiments.

### DETAILED DESCRIPTION OF THE PREFERRED EMBODIMENT

The present invention provides a composition for controlling and preventing bacterial wilt, which prevents and/or controls bacterial wilt caused by Ralstonia solanacearum in plants susceptible to the disease.

In some embodiments, the composition of the present invention is a concentrate composition for controlling and preventing bacterial wilt, comprises between about 1 g/L to about 50 g/L auxin and between about 5 g/L to about 50 g/L cytokinin.

In some embodiments, the auxin is selected from the group consisting of indole-3-butyric acid (IBA), indole-3-acetic acid (IAA), 1-Naphthaleneacetic acid (NAA), and 4-Dichlorophenoxyacetic acid (2,4-D). In some embodiments, the auxin is IBA.

In some embodiments, the concentration of auxin in the concentrate composition is between about 1 g/L to about 50 g/L, between about 3.5 g/L to about 40 g/L, between about 3.5 g/L to about 30 g/L, between about 3.5 g/L to about 20 g/L, between about 3.5 g/L to about 10 g/L, between about 3.5 g/L to about 5 g/L, and preferably is, but is not limited to, about 1 g/L, about 2 g/L, about 3 g/L, about 4 g/L, about 5 g/L, about 6 g/L, about 7 g/L, about 8 g/L, about 9 g/L, about 10 g/L, about 11 g/L, about 12 g/L, about 13 g/L, about 14 g/L, about 15 g/L, about 16 g/L, about 17 g/L, about 18 g/L, about 19 g/L, about 20 g/L, about 21 g/L, about 22 g/L, about 23 g/L, about 24 g/L, about 25 g/L, about 26 g/L, about 27 g/L, about 28 g/L, about 29 g/L, about 30 g/L, about 31 g/L, about 32 g/L, about 33 g/L, about 34 g/L, about 35 g/L, about 36 g/L, about 37 g/L, about 38 g/L, about 39 g/L, about 40 g/L, about 41 g/L, about 42 g/L, about 43 g/L, about 44 g/L, about 45 g/L, about 46 g/L, about 47 g/L, about 48 g/L, about 49 g/L, about 50 g/L, or any concentration between about 1 g/L to about 50 g/L, such as about 1.25 g/L, about 1.5 g/L, about 1.75 g/L. In some embodiments, the concentration of auxin in the concentrate composition is about 3.5 g/L, about 5 g/L, about 10 g/L, about 15 g/L, about 20 g/L, or about 25 g/L.

In some embodiments, the cytokinin is selected from the group consisting of N6-furfuryladenine (Kinetin), 6-Benzylaminopurine (BA), zeatin (ZT), 6-(γ, γ-Dimethylallylamino)purine (2iP), diphenylurea, and thidiazuron (TDZ). In some embodiments, the cytokinin is Kinetin.

In some embodiments, the concentration of cytokinin in the concentrate composition is between about 5 g/L to about 50 g/L, between about 10 g/L to about 40 g/L, between about 15 g/L to about 30 g/L, between about 15 g/L to about 25 g/L, between about 15 g/L to about 20 g/L, and preferably is, but is not limited to, about 5 g/L, about 6 g/L, about 7 g/L, about 8 g/L, about 9 g/L, about 10 g/L, about 11 g/L, about 12 g/L, about 13 g/L, about 14 g/L, about 15 g/L, about 16 g/L, about 17 g/L, about 18 g/L, about 19 g/L, about 20 g/L, about 21 g/L, about 22 g/L, about 23 g/L, about 24 g/L, about 25 g/L, about 26 g/L, about 27 g/L, about 28 g/L, about 29 g/L, about 30 g/L, about 31 g/L, about 32 g/L, about 33 g/L, about 34 g/L, about 35 g/L, about 36 g/L, about 37 g/L, about 38 g/L, about 39 g/L, about 40 g/L, about 41 g/L, about 42 g/L, about 43 g/L, about 44 g/L, about 45 g/L, about 46 g/L, about 47 g/L, about 48 g/L, about 49 g/L, about 50 g/L, or any concentration between about 5 g/L to about 50 g/L, such as about 10.25 g/L, about 22.8 g/L, about 37.75 g/L. In some embodiments, the concentration of cytokinin in the concentrate composition is about 5 g/L, about 10 g/L, about 15 g/L, about 20 g/L, or about 25 g/L.

In some embodiments, the composition of the present invention is a ready to use composition for controlling and preventing bacterial wilt, comprises between about 1 mg/L to about 50 mg/L auxin and between about 5 mg/L to about 50 mg/L cytokinin.

In some embodiments, the concentration of auxin in the ready to use composition is between about 1 mg/L to about 50 mg/L, between about 3.5 mg/L to about 40 mg/L, between about 3.5 mg/L to about 30 mg/L, between about 3.5 mg/L to about 20 mg/L, between about 3.5 mg/L to about 10 mg/L, between about 3.5 mg/L to about 5 mg/L, and preferably is, but is not limited to, about 1 mg/L, about 2 mg/L, about 3 mg/L, about 4 mg/L, about 5 mg/L, about 6 mg/L, about 7 mg/L, about 8 mg/L, about 9 mg/L, about 10 mg/L, about 11 mg/L, about 12 mg/L, about 13 mg/L, about 14 mg/L, about 15 mg/L, about 16 mg/L, about 17 mg/L, about 18 mg/L, about 19 mg/L, about 20 mg/L, about 21 mg/L, about 22 mg/L, about 23 mg/L, about 24 mg/L, about 25 mg/L, about 26 mg/L, about 27 mg/L, about 28 mg/L, about 29 mg/L, about 30 mg/L, about 31 mg/L, about 32 mg/L, about 33 mg/L, about 34 mg/L, about 35 mg/L, about 36 mg/L, about 37 mg/L, about 38 mg/L, about 39 mg/L, about 40 mg/L, about 41 mg/L, about 42 mg/L, about 43 mg/L, about 44 mg/L, about 45 mg/L, about 46 mg/L, about 47 mg/L, about 48 mg/L, about 49 mg/L, about 50 mg/L, or any concentration between about 1 mg/L to about 50 mg/L, such as about 1.25 mg/L, about 1.5 mg/L, about 1.75 mg/L. In some embodiments, the concentration of auxin in the ready to use composition is about 3.5 mg/L, about 5 mg/L, about 10 mg/L, about 15 mg/L, about 20 mg/L, or about 25 mg/L.

In some embodiments, the concentration of cytokinin in the ready to use composition is between about 5 mg/L to about 50 mg/L, between about 10 mg/L to about 40 mg/L, between about 15 mg/L to about 30 mg/L, between about 15 mg/L to about 25 mg/L, between about 15 mg/L to about 20 mg/L, and preferably is, but is not limited to, about 5 mg/L, about 6 mg/L, about 7 mg/L, about 8 mg/L, about 9 mg/L, about 10 mg/L, about 11 mg/L, about 12 mg/L, about 13 mg/L, about 14 mg/L, about 15 mg/L, about 16 mg/L, about 17 mg/L, about 18 mg/L, about 19 mg/L, about 20 mg/L, about 21 mg/L, about 22 mg/L, about 23 mg/L, about 24 mg/L, about 25 mg/L, about 26 mg/L, about 27 mg/L, about 28 mg/L, about 29 mg/L, about 30 mg/L, about 31 mg/L, about 32 mg/L, about 33 mg/L, about 34 mg/L, about 35 mg/L, about 36 mg/L, about 37 mg/L, about 38 mg/L, about 39 mg/L, about 40 mg/L, about 41 mg/L, about 42 mg/L, about 43 mg/L, about 44 mg/L, about 45 mg/L, about 46 mg/L, about 47 mg/L, about 48 mg/L, about 49 mg/L, about 50 mg/L, or any concentration between about 5 mg/L to about 50 mg/L, such as about 10.25 mg/L, about 22.8 mg/L, about 37.75 mg/L. In some embodiments, the concentration of cytokinin in the ready to use composition is about 5 mg/L, about 10 mg/L, about 15 mg/L, about 20 mg/L, or about 25 mg/L.

In some embodiments, the composition for controlling and preventing bacterial wilt of the present invention may include one or more adjuvant. In other embodiments, the composition for controlling and preventing bacterial wilt of the present invention may not include an adjuvant. For example, the composition may include a surfactant and/or a drift control agent. Exemplary surfactants include, but are not limited to, cationic surfactants, anionic surfactants, zwitterionic surfactants, and nonionic surfactants, preferably including but not limited to, Tween 20, Tween 40, Tween 60, Tween 65, Tween 80, Tween 85, Laureth-4, Ceteth-2, Ceteth-20, Steareth-2, PEG40, PEG100, PEG150, PEG200, PEG600, Span 20, Span 40, Span 60, Span 65, Span 80. An exemplary drift control agent includes LI 700®, which is commercially available from Loveland Products (Loveland, Colo., USA).

In some embodiments, the concentration of the adjuvant in the ready to use composition is 0.01˜1% (v/v), and preferably is, but is not limited to, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1% (v/v). In some embodiments, the concentration of the adjuvant in the ready to use composition is 0.1% (v/v).

Suitable concentration ranges for the concentrate composition of the present invention are provided in Table 1, and suitable concentration ranges for the ready to use composition of the present invention are provided in Table 2. In some embodiments, the concentrate composition and the ready to use composition can consist of or consist essentially of the components listed in Table 1 and 2, respectively.

TABLE 1
Suitable concentrate composition

| | First example | Second example | Third example |
|---|---|---|---|
| Component | range (g/L) | range (g/L) | range (g/L) |
| Auxin | 0.1-500 | 0.5-100 | 1-50 |
| Cytokinin | 0.5-500 | 1-100 | 5-50 |

TABLE 2
Suitable ready to use composition

| | First example | Second example | Third example |
|---|---|---|---|
| Component | range (mg/L) | range (mg/L) | range (mg/L) |
| Auxin | 0.1-500 | 0.5-100 | 1-50 |
| Cytokinin | 0.5-500 | 1-100 | 5-50 |

The invention also provides a method for controlling and preventing bacterial wilt, including a step of applying a ready to use composition for controlling and preventing bacterial wilt to a plant susceptible to bacterial wilt. The ready to use composition for controlling and preventing bacterial wilt comprises between about 1 mg/L to about 50 mg/L auxin and between about 5 mg/L to about 50 mg/L cytokinin.

In some embodiments, the plant susceptible to bacterial wilt is a host plant of R. solanacearum. In some embodiments, the plant susceptible to bacterial wilt is a plant of Solanaceae family.

In some embodiments, the composition of the present invention is applied to plant foliage (for example, leaves, stems, flowers and/or fruits), for example as a foliar application or foliar spray. In some embodiments, the composition of the present invention is applied to plant roots, such as by a soil application or soil drench, and/or to seeds, such as by a seed treatment.

In some embodiments, the composition of the present invention is applied to a target plant during the vegetative phase. In some embodiments, the composition of the present invention is applied to a target plant during the reproductive phase.

In some embodiments, the composition of the present invention is applied to a target plant before infection with R. solanacearum. In some embodiments, the composition of the present invention is applied to a target plant 0, 1, 2, 3, 4, 5, 6, 7, 8, 9, 10 days post infection with R. solanacearum. In some embodiments, the composition of the present invention is applied to a target plant before and after infection with R. solanacearum.

The composition of the present invention has demonstrated remarkable decreases in disease severity scores, leading to increasing survival rate in target plants. It has been found that when auxin and cytokinin are combined in the composition of the present invention, the plant growth regulating actions of the respective components are increased synergistically, and the combination of the components exhibits a marked synergistic effect not seen when the components are used individually.

Unless otherwise defined, all technical and scientific terms used herein have the same meaning as commonly understood by one of ordinary skill in the art to which this invention pertains. In the case of conflict, the present document, including definitions will control.

As used herein, the term “bacterial wilt” refers to a plant disease caused by Ralstonia solanacearum, which is a soil-borne bacterium that enters plant roots and stem bases through wounds or openings. The first symptoms of bacterial wilt can easily go unnoticed because the leaves stay green but eventually the entire plant wilts and dies. Brown discoloration and decay are evident inside the stems of infected plants. Bacterial wilt is easily diagnosed by suspending a clean, cut section of diseased stem in clear water. If a white milky trail consisting of countless bacteria exudes from the infected stems within minutes, it indicates the occurrence of bacterial wilt.

As used herein, the term “a plant susceptible to bacterial wilt” refers to a plant in which its growth can be influenced by the infection of Ralstonia solanacearum. Examples of a plant susceptible to bacterial wilt include, but are not limited to, tomato, potato, eggplant, pepper, sweet pepper, tobacco, peanut, beefsteak plant, radish, sweet potato, ginger, sponge gourd, bitter melon, water spinach, mint, Ricinus, snake jasmine (Rhinacanthus nasutus), Salix argyracea, Texas bluebell, bird of paradise flower, painter's-palette, Siam tulip, sunflower, roselle, strawberry, Java apple, sugar apple, eucalyptus, Bishop wood (Bischofia javanica).

As used herein, the term “auxin” refers to a class of plant growth regulators that promote stem elongation, inhibit growth of lateral buds, and therefore maintain apical dominance. Naturally occurring (endogenous) auxins are produced by apical meristem, such as stem tips and root tips. Auxin moves to the darker side of the plant, causing the cells there to grow longer than corresponding cells on the lighter side of the plant, and this produces a curving of the plant stem tip toward the light. Examples of auxin include, but are not limited to, indole-3-butyric acid (IBA), indole-3-acetic acid (IAA), 4-chloroindole-3-acetic acid (4-CI-IAA), 2-phenylacetic acid (PAA), indole-3-propionic acid (IPA), 1-naphthaleneacetic acid (NAA), 2,4-dichlorophenoxyacetic acid (2,4-D), 2-methoxy-3,6-dichlorobenzoic acid (dicamba), 4-amino-3,5,6-trichloropicolinic acid (tordon), and 2,4,5-trichlorophenoxyacetic acid (2,4,5-T).

As used herein, the term “cytokinin” refers to a class of plant growth regulators that enhance cell division, cell differentiation, and axillary bud growth, and inhibit apical dominance. There are two types of cytokinins based on their chemical structures: adenine-type and phenylurea-type cytokinin. Most cytokinins are synthesized in root tip and transported to photosynthetic tissues through xylem. Although roots are the major site of cytokinin biosynthesis, they are not the only site. Cambium and possibly all actively dividing tissues, such as embryo, leaves, fruits, are responsible for the synthesis of cytokinin. Examples of cytokinin include, but are not limited to, N6-furfuryladenine (kinetin), 6-Benzylaminopurine (BA), zeatin (ZT), N6-(2-isopentenyl) adenine (2ip), diphenylurea (DPU), and thidiazuron (TDZ).

As used herein, the term “surfactants” refers to molecules with the chemical formula RCOOM, where R is a long-chain alkyl group and M is a base, and therefore, surfactants are molecules containing both lipophilic groups (the long-chain alkyl group) and hydrophilic groups, which allow oily substances to be dispersed or dissolved in water.

The surfactants described herein include, but are not limited to, cationic surfactants, anionic surfactants, zwitterionic surfactants, and non-ionic surfactants, such as Tween series, Laureth series, Ceteth series, Steareth series, PEG series, and Span series.

As used herein, the term “control” means capable of reducing, stopping progression, slowing progression, advantageously changing, eliminating, or a combination thereof, any aspect of a disease, disorder, or a combination thereof.

As used herein, the term “prevention” means capable of stopping any aspect of a disease, disorder, or combination thereof from occurring.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

The term “a,” “an,” or “the” disclosed in the present invention is intended to cover one or more numerical values in the specification and claims unless otherwise specified. For example, “an element” indicates one or more than one element.

It is to be understood that both the foregoing general description and the following detailed description are exemplary and explanatory only and are not restrictive of the invention.

### EXAMPLES

### Example 1

### 1. Preparation of Plant Samples

Beef tomato seeds (Farmers 301, Known-You Seed Co, Ltd., Kaohsiung, Taiwan) were seeded in pots containing culture medium (peat soil: vermiculite=3:2). Tomato seedlings were transferred to 4-inch pots at 20 days post seeding for test.

### 2. Plant Treatment

Tomato seedlings were inoculated with Ralstonia solanacearum (10⁸ CFU/mL, 25 mL per pot) and kept in a phytotron, which was operated at 26±3° C., 70-80% humidity, and on a 12-hour light-dark cycle. Then, the tomato seedlings were applied with the reagents listed in Table 3 twice, at 3 and 10 days post infection, respectively, using a foliar spray treatment. The plants were kept in the phytotron for further analysis. There were 4 groups in this test, 1 Control group and 3 Test groups. Each group had 12 plants (n=12).

Control group: 0.1% (v/v) Tween 80 solution was applied to plant foliage twice.

Test group 1-1: 5 mg/L IBA mixed with 0.1% (v/v) Tween 80 solution was applied to plant foliage twice.

Test group 1-2: 15 mg/L Kinetin mixed with 0.1% (v/v) Tween 80 solution was applied to plant foliage twice.

Test group 1-3: 5 mg/L IBA and 15 mg/L Kinetin mixed with 0.1% (v/v) Tween 80 solution were applied to plant foliage twice.

### 3. Analysis

a. Disease Severity

Each plant was rated for bacterial wilt severity at 9, 11, and 13 days post infection.

Severity was evaluated based on a 0-5 disease scale, where 0 indicates the plant having no symptoms of wilting, 1 indicates the plant showing mild symptoms of wilting, 2 indicates 50% of the plant showing wilting, 3 indicates 75% of the plant showing wilting, 4 indicates 100% of the plant showing wilting, and 5 indicates plant death.

Statistical analyses: Average and standard deviation (S.D.) of each group (n=12) were calculated. Statistically significant differences between control group and test groups were assessed by Student's unpaired two-tailed t-test, where p-value<0.05 was considered a significant difference and indicated by an asterisk (*). In addition, statistically significant differences between test group 1-1 and test group 1-3 and statistically significant differences between test group 1-2 and test group 1-3 were also assessed by Student's unpaired two-tailed t-test, where p-value<0.05 was considered a significant difference and indicated by crosses (†) and double crosses (‡), respectively.

b. Survival Rate

Plants with a severity score of 5, which indicates plant death, were numbered at 13 days post infection. Survival rate of each group was calculated with the following equation.

Survival rate=[(total number of plants−number of plants with a severity score of 5)/total number of plants]×100%.

### 4. Results

As shown in Table 3, tomato plants treated with the composition of the present invention (Test group 1-3) have significantly lower severity scores and higher survival rate than tomato plants treated with auxin only (Test group 1-1) or cytokinin only (Test group 1-2) and plants in Control group. In contrast, after 11 days post infection, there is no statistically significant differences between the severity scores of plants treated with auxin only (Test group 1-1) or cytokinin only (Test group 1-2) and the severity scores of control group. The results indicate that the composition of the present invention has a synergistic effect on resistance to R. solanacearum and increases the survival rate of infected plants.

TABLE 3
Severity scores at different days post infection (dpi) and
survival rates at 13 dpi of test plants in Example 1.

| | | Severity score at days post | | | Survival |
|---|---|---|---|---|---|
| | | infection (dpi) | | | Rate |
| Group | Components | 9 | 11 | 13 | (13 dpi) |
| Control | 0.1% (v/v) | 1.17 | 2.42 | 3.75 | 42% |
| group | Tween 80 | | | | |
| Test | 5 mg/L IBA + | 0.25* | 2.50 | 3.25 | 58% |
| group | 0.1% (v/v) | | | | |
| 1-1 | Tween 80 | | | | |
| Test | 15 mg/L | 0.42 | 2.08 | 3.17 | 58% |
| group | Kinetin + | | | | |
| 1-2 | 0.1% (v/v) | | | | |
| | Tween 80 | | | | |
| Test | 5 mg/L IBA + | 0.00** | 0.33** | 1.58**, †, ‡ | 100% |
| group | 15 mg/L | | | | |
| 1-3 | Kinetin + | | | | |
| | 0.1% (v/v) | | | | |
| | Tween 80 | | | | |

*p < 0.05; **p < 0.01, Control group vs. Test group 1-1, 1-2, or 1-3.
† p < 0.05, Test group 1-1 vs. Test group 1-3.
‡ p < 0.05, Test group 1-2 vs. Test group 1-3.

### Example 2

### 1. Preparation of Plant Samples

Seedlings of beef tomato (Farmers 301) were used as test plants in this Example.

Preparation of the test plants was as described in Example 1.

### 2. Plant Treatment

Tomato seedlings were inoculated with R. solanacearum (10⁸ CFU/mL, 25 mL per pot) and kept in a phytotron, which was operated at 26±3° C., 70-80% humidity, and on a 12-hour light-dark cycle. Then, the tomato seedlings were applied with the reagents listed in Table 4 twice, at 3 and 10 days post infection, respectively, using a soil drench treatment.

The plants were kept in the phytotron for further analysis. There were 4 groups in this test, 1 Control group and 3 Test groups. Each group had 12 plants (n=12).

Control group: double distilled water (D.D.W.) was applied to plant roots twice.

Test group 2-1: 5 mg/L IBA was applied to plant roots twice.

Test group 2-2: 15 mg/L Kinetin was applied to plant roots twice.

Test group 2-3: 5 mg/L IBA and 15 mg/L Kinetin were applied to plant roots twice.

### 3. Analysis

a. Disease Severity

Each plant was rated for bacterial wilt severity at 9, 11, and 13 days post infection. The severity scores are as described in Example 1.

Statistical analyses are as described in Example 1.

b. Survival Rate

Plants with a severity score of 5, which indicates plant death, were numbered at 13 days post infection. Equation of survival rate is as described in Example 1.

### 4. Results

As shown in Table 4, tomato plants treated with the composition of the present invention (Test group 2-3) have significantly lower severity scores and higher survival rate than tomato plants treated with auxin only (Test group 2-1) or cytokinin only (Test group 2-2) and plants in Control group. In contrast, at 13 days post infection, there is no statistically significant differences between the severity scores of plants treated with auxin only (Test group 2-1) or cytokinin only (Test group 2-2) and the severity scores of control group.

The results indicate that applying the composition of the present invention to the roots of a plant infected with R. solanacearum increases resistance to R. solanacearum and survival rate of the infected plants.

TABLE 4
Severity scores at different days post infection (dpi) and
survival rates at 13 dpi of test plants in Example 2.

| | | Severity score at days post | | | Survival |
|---|---|---|---|---|---|
| | | infection (dpi) | | | Rate |
| Group | Components | 9 | 11 | 13 | (13 dpi) |
| Control | Double distilled | 1.25 | 2.50 | 3.92 | 50% |
| group | water (D.D.W.) | | | | |
| Test group | 5 mg/L IBA | 0.25* | 1.00* | 2.50 | 67% |
| 2-1 | | | | | |
| Test group | 15 mg/L Kinetin | 0.25* | 1.08* | 2.58 | 75% |
| 2-2 | | | | | |
| Test group | 5 mg/L IBA + | 0.08* | 0.75** | 1.00***, †, ‡ | 100% |
| 2-3 | 15 mg/L Kinetin | | | | |

*p < 0.05; **p < 0.01; ***p < 0.001, Control group vs. Test group 2-1, 2-2, or 2-3.
† p < 0.05, Test group 2-1 vs. Test group 2-3.
‡ p < 0.05, Test group 2-2 vs. Test group 2-3.

### Example 3

### 1. Preparation of Test Plants

Seedlings of beef tomato (Farmers 301) were used as test plants in this Example. Preparation of the test plants was as described in Example 1.

### 2. Plant Treatment

Tomato seedlings were applied with the reagents listed in Table 5 once using a soil drench treatment before inoculation with R. solanacearum (10⁸ CFU/mL, 25 mL per pot) and kept in a phytotron, which was operated at 26±3° C., 70-80% humidity, and on a 12/12 hour cycle. Then, the tomato seedlings were applied with the reagents listed in Table 5 two more times, at 3 and 10 days post infection, respectively, using a soil drench treatment. The plants were kept in the phytotron for further analysis. There were 5 groups in this test, 1 Control group and 4 Test groups. Each group had 12 plants (n=12).

Control group: double distilled water (D.D.W.) was applied to plant roots three times.

Test group 3-1: 5 mg/L IBA was applied to plant roots three times.

Test group 3-2: 20 mg/L Kinetin was applied to plant roots three times.

Test group 3-3: 5 mg/L IBA and 20 mg/L Kinetin were applied to plant roots three times.

Test group 3-4: 3.5 mg/L IBA and 20 mg/L Kinetin were applied to plant roots three times.

### 3. Analysis

a. Disease Severity

Each plant was rated for bacterial wilt severity at 9, 11, and 13 days post infection. The severity scores are as described in Example 1.

Statistical analyses are as described in Example 1.

b. Survival Rate

Plants with a severity score of 5, which indicates plant death, were numbered at 13 days post infection. Equation of survival rate is as described in Example 1.

### 4. Results

As shown in Table 5, tomato plants treated with the composition of the present invention (Test groups 3-3 and 3-4) have significantly lower severity scores and higher survival rate than tomato plants treated with auxin only (Test group 3-1) or cytokinin only (Test group 3-2) and plants in Control group. In contrast, at 9 and 11 days post infection, there is no statistically significant differences between the severity scores of plants treated with auxin only (Test group 3-1) or cytokinin only (Test group 3-2) and the severity scores of control group. The results indicate that applying the composition of the present invention to the roots of a plant infected with R. solanacearum increases resistance to R. solanacearum and survival rate of the infected plants.

TABLE 5
Severity scores at different days post infection (dpi) and survival
rates at 13 dpi of test plants in Example 3.

| | | Severity score at days post | | | Survival |
|---|---|---|---|---|---|
| | Com- | infection (dpi) | | | Rate |
| Group | ponents | 9 | 11 | 13 | (13 dpi) |
| Control | Double | 1.50 | 2.75 | 3.83 | 42% |
| group | distilled | | | | |
| | water | | | | |
| | (D.D.W.) | | | | |
| Test | 5 mg/L | 0.92 | 1.58 | 2.17* | 75% |
| group | IBA | | | | |
| 3-1 | | | | | |
| Test | 20 mg/L | 0.83 | 1.42 | 2.08* | 75% |
| group | Kinetin | | | | |
| 3-2 | | | | | |
| Test | 5 mg/L | 0.00* | 0.25*** | 0.25***, ††, ‡‡ | 100% |
| group | IBA + | | | | |
| 3-3 | 20 mg/L | | | | |
| | Kinetin | | | | |
| Test | 3.5 mg/L | 0.00* | 0.17*** | 0.42***, †, ‡ | 100% |
| group | IBA + | | | | |
| 3-4 | 20 mg/L | | | | |
| | Kinetin | | | | |

*p < 0.05; ***p < 0.001, Control group vs. Test group 3-1, 3-2, 3-3, or 3-4.
† p < 0.05; †† p < 0.01, Test group 3-1 vs. Test group 3-3 or 3-4.
‡ p < 0.05; ‡‡ p < 0.01, Test group 3-2 vs. Test group 3-3 or 3-4.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A concentrate composition for controlling and preventing bacterial wilt, comprising between about 1 g/L to about 50 g/L auxin and between about 5 g/L to about 50 g/L cytokinin.

2. The concentrate composition of claim 1, wherein the auxin is indole-3-butyric acid (IBA), and the cytokinin is N6-furfuryladenine (Kinetin).

3. The concentrate composition of claim 1, further comprising a drift control agent.

4. The concentrate composition of claim 1, wherein the concentrate composition is diluted 1000 folds before use.

5. The concentrate composition of claim 1, wherein the composition consists essentially of between about 1 g/L to about 50 g/L auxin and between about 5 g/L to about 50 g/L cytokinin.

6. The concentrate composition of claim 5, wherein the auxin is indole-3-butyric acid (IBA), and the cytokinin is N6-furfuryladenine (Kinetin).

7. A ready to use composition for controlling and preventing bacterial wilt, comprising between about 1 mg/L to about 50 mg/L auxin and between about 5 mg/L to about 50 mg/L cytokinin.

8. The ready to use composition of claim 7, wherein the auxin is indole-3-butyric acid (IBA), and the cytokinin is N6-furfuryladenine (Kinetin).

9. The ready to use composition of claim 7, further comprising 0.01-1% (v/v) adjuvant.

10. The ready to use composition of claim 9, wherein the adjuvant is selected from a surfactant and a drift control agent.

11. The ready to use composition of claim 7, wherein the ready to use composition consists essentially of between about 1 mg/L to about 50 mg/L auxin and between about 5 mg/L to about 50 mg/L cytokinin.

12. The ready to use composition of claim 11, wherein the auxin is indole-3-butyric acid (IBA), and the cytokinin is N6-furfuryladenine (Kinetin).

13. A method for controlling and preventing bacterial wilt, comprising a step of applying a ready to use composition for controlling and preventing bacterial wilt to a plant susceptible to bacterial wilt, wherein the ready to use composition for controlling and preventing bacterial wilt comprises between about 1 mg/L to about 50 mg/L auxin and between about 5 mg/L to about 50 mg/L cytokinin.

14. The method of claim 13, wherein the auxin is indole-3-butyric acid (IBA), and the cytokinin is N6-furfuryladenine (Kinetin).

15. The method of claim 13, wherein the ready to use composition for controlling and preventing bacterial wilt is applied to the roots of the plant.

16. The method of claim 13, wherein the ready to use composition for controlling and preventing bacterial wilt further comprises 0.01 to 1% (v/v) adjuvant.

17. The method of claim 16, wherein the adjuvant is selected from a surfactant and a drift control agent.

18. The method of claim 16, wherein the ready to use composition for controlling and preventing bacterial wilt is applied to the foliage of the plant.

19. The method of claim 13, wherein the ready to use composition for controlling and preventing bacterial wilt is applied to the plant before infection of Ralstonia solanacearum.

20. The method of claim 13, wherein the ready to use composition for controlling and preventing bacterial wilt is applied to the plant after infection of Ralstonia solanacearum.
